(19) United States
(12) Patent Application Publication
(10) Pub. No.: US 2018/0137248 A1
(43) Pub. Date: May 17, 2018

(54) METHOD AND COMPUTER FOR SCHEDULING THE OPERATION OF AN IMAGE ACQUISITION APPARATUS

(71) Applicant: Siemens Healthcare GmbH, Erlangen (DE)

(72) Inventors: Georg Goertler, Baiersdorf (DE); Stephan Kannengiesser, Wuppertal (DE); Eva Rothgang, Schwaig bei Nuernberg (DE)

(73) Assignee: Siemens Healthcare GmbH, Erlangen (DE)

(21) Appl. No.: 15/814,858

(22) Filed: Nov. 16, 2017

(30) Foreign Application Priority Data
Nov. 16, 2016 (DE) 102016222524.3

(51) Int. Cl. G06F 19/00; G06Q 10/06

(52) U.S. Cl. CPC G06F 19/327; G06K 9/20; G06F 19/3443; G06Q 10/06311

(57) ABSTRACT

In a method and computer for creating a usage schedule during a usage phase of an image acquisition apparatus, time slots of the usage phase are assigned to examinations of a patient that use at least one measurement protocol. The scheduling is performed using examination durations associated with the examinations based on at least one examination parameter specifying the examination and/or at least one patient parameter specifying the patient, as input data, determined by an analysis algorithm using operating data that are recorded during the operation of the image acquisition apparatus and/or an image acquisition apparatus allocated to a group of image acquisition apparatuses of the same imaging modality.

### BACKGROUND OF THE INVENTION

### Field of the Invention

The present invention concerns a method for scheduling the operation of an image acquisition apparatus, wherein for the purpose of creating a usage schedule during a usage phase of the image acquisition device, time slots of the usage phase are assigned to examinations of a patient to be examined that use at least one measurement protocol. The invention also concerns a scheduling computer and an electronically readable data carrier designed to implement such a method.

### Description of the Prior Art

Modern medical image acquisition apparatuses provide patient image data that are of value diagnostically and/or in helping to plan a treatment. Image acquisition apparatuses that provide image data of this high quality, for instance magnetic resonance apparatuses or computed tomography apparatuses, usually are a major purchase for a medical examination center, for example a radiology clinic or a hospital, so that optimum utilization is usually desirable. This applies in particular to image acquisition apparatuses, for which more prolonged and/or more complicated pre- and/or post-steps for a patient are needed, for instance in the case of magnetic resonance apparatuses. In order to achieve optimum utilization of such an image acquisition apparatus, which means minimizing the idle period between examinations of individual patients while guaranteeing reliable appointment scheduling, it is essential to have exact knowledge of the examination duration, which includes the patient pre- and post-procedures, as well as actions for room cleaning and the like.

For current scheduling procedures performed manually, it is known to provide a measurement time to a person performing the usage scheduling, in other words to specify how long it takes to perform the measurement protocol itself. These figures do not allow for any adjustments and user interactions, however. These measurement times do not often include times around the actual measurement procedure, for instance patient care and/or arranging the room before and after the procedure, nor do they include times between individual measurement protocols, for instance for user interaction.

Therefore, in order to be able to utilize the image acquisition apparatus optimally, excellent organization and/or extensive experience in examination durations are required on the part of those performing the manual usage scheduling of an image acquisition apparatus. Hence in many medical examination centers, for example hospitals and/or clinics, fixed examination durations, for instance of 30 minutes, are scheduled as the “timeslot” in the usage phase, and because of the varying examination durations in practice, this can result in imprecise appointment times and hence in greater effort and lack of patient convenience, which can mean, for example, that patients must additionally be transported from and to the image acquisition apparatus or must wait for a long time. In addition, such approaches have the problem that idle times may arise.

### SUMMARY OF THE INVENTION

An object of the invention is to provide a way to improve the utilization of usage phases of an image acquisition apparatus.

This object is achieved according to the invention by a method of the type wherein the scheduling is performed using examination durations, which are associated with the examinations on the basis of at least one examination parameter specifying the examination and/or of at least one patient parameter specifying the patient as input data, and which are determined by execution of an analysis algorithm, which analysis algorithm determines the examination durations using operating data that are recorded automatically during the operation of the image acquisition device and/or an image acquisition apparatuses allocated to an identical group of image acquisition devices of the same imaging modality, which operating data relates to the respective recording image acquisition apparatus.

The invention provides a way to determine or predict, for comparable examinations, examination durations that will extend beyond the known, or determinable, time length of measurements for the measurement protocol, by using operating data recorded in the past for a particular image acquisition apparatus, or an image acquisition apparatus belonging to the same group. Such operating data may be, for example, system events with an associated time stamp, so that time periods between actual measurement activity, pauses in the measurement activity and/or changes in the measurement activity with respect to the protocol can also be deduced by analyzing this technical operating data. The term “examination” in the context of the present invention therefore includes, in addition to the pure execution of the at least one measurement protocol, patient care, in particular pre- and post-arrangements for the patient, and/or care of the surroundings, in particular pre- and post-arrangements for the examination room, for instance cleaning processes between individual examinations.

The fully automatic analysis of technical operating data from the image acquisition devices allows more accurate knowledge about the likely examination periods of future examinations, which means better utilization of the image acquisition device, in particular the idle time between different examinations can be minimized while ensuring reliable appointment scheduling. The invention is based on learning, over the usage phases of the at least one image acquisition apparatus, how long specific examinations last, including pre- and/or post-arrangements. This learned data, i.e. examination durations that can be derived by the analysis algorithm, can then be used for scheduling a usage phase of the image acquisition apparatus. Thus an approach based on data mining is defined in order to learn exact examination durations and to be able to estimate variables, for instance relating to patient positioning, as precisely as possible.

This provides the following advantages, which are summarized and expanded upon below. Better utilization of the image acquisition device is possible because no time buffers or fewer time buffers need to be included in the schedule. The organizational effort is reduced because examination times can be scheduled more precisely. The waiting times for the individual patients are reduced, giving greater patient convenience. No user input is required because determining the examination durations and preferably also the actual scheduling proceed automatically. It should also be mentioned that the technology described here can be applied irrespective of the actual patient throughput.

A magnetic resonance apparatus or computed tomography apparatus can be used as the at least one image acquisition apparatus. It should be noted that the method according to the invention can be applied particularly advantageously to magnetic resonance apparatus because the pre-arrangement and post-arrangement stages for these devices can be rather complex, which conventionally has made it significantly harder to estimate times for these stages. For example, patients need to be positioned correctly and/or provided with local coils and the like. Therefore a significant gain in time and efficiency can be achieved in particular with magnetic resonance apparatuses.

Furthermore, the method is specifically aimed at a single image acquisition apparatus, or at a group of image acquisition apparatuses of the same imaging modality, wherein preferably a group is used that includes all the image acquisition apparatuses of an imaging modality in a particular medical examination center. This examination center may be a radiology clinic or a hospital, for example. The analysis of the technical operating data, which, for instance, a control computer in the image acquisition apparatus automatically records and provides, hence takes into account the individual circumstances, for instance the staff, special treatment types and treatment instructions and the like, for a specific image acquisition apparatus and/or a specific medical examination center, thereby allowing the analysis algorithm to determine examination durations on an individualized basis. Optimizing the utilization of the image acquisition apparatus during a usage phase thus can also take specific account of circumstances for the image acquisition apparatus or the group of image acquisition apparatuses. An example of a group of image acquisition apparatuses are all the magnetic resonance apparatuses in a hospital or a radiology clinic, for instance.

Two fundamental approaches are conceivable here to address how the analysis algorithm can learn examination durations from operating data from the past that was recorded automatically by the image acquisition device. Thus in a first embodiment of the present invention, the examination durations are determined, at least in part, by statistical consideration of time values that are derived from the operating data and that describe examination classes in which examinations are grouped. These examination classes can themselves be predefined manually, for instance from empirical values, and group together examinations that are comparable in terms of examination durations and effects that arise, which can be derived from the operating data, for which examinations individual statistical analyses are performed using the analysis algorithm. For example, the examination classes can be defined by specified ranges and/or values of the input data. The technical operating data of the at least one image acquisition device are then defined according to the examination classes, and time values are determined, from which the examination durations are derived, which go beyond the pure measurement time, i.e. beyond the precise duration for the execution of the at least one measurement protocol. For this purpose, a statistical analysis is used to determine, for the examination class, an examination duration, which includes an associated scattering parameter, which defines the time variability. In simple cases, time periods between measurement events can be considered as the time values, for instance, but precise classifications and analyses are also conceivable, for instance if events such as the connection of additional devices, such as local coils and the like, are recorded in the technical operating data.

It should be noted that the statistical analysis can also be performed over a sliding time window, and/or older operating data can be incorporated in the statistical analysis with a lower weighting than more recent operating data. If, for example, before scheduling the usage for a following day and/or a following week, the operating data acquired in the most recent usage phases, which have not yet been registered, are used to update the statistically determined examination durations, ultimately, by virtue of the analysis algorithm, extremely recent examination durations that also capture trends are always available. In other words, examination durations are literally “up to date”.

In another embodiment of the present invention, a self-learning algorithm in artificial intelligence is used as the analysis algorithm, the training data for which includes at least some of the operating data and/or are derived automatically therefrom. Self-learning algorithms in artificial intelligence are well known under the designation “machine learning” and can also be used particularly advantageously in the context of the present invention, for example in the form of a neural network or the like. This can be used to perform ultimately a more accurate, implicit analysis than by classifying into examination classes, because the self-learning algorithm in artificial intelligence finds relationships between input data and examination durations by analyzing the training data and hence the operating data itself. The self-learning algorithm is updated in artificial intelligence regularly, for instance on the basis of the most recently recorded operating data, in order to be able to respond to changes to the at least one image acquisition apparatus. In particular, self-learning algorithms in artificial intelligence are also known that are able to recognize trends and take these trends into account appropriately in their current output results, in this case examination durations. Algorithms designed in this way are particularly suitable as analysis algorithms in the context of the present invention.

In order to be able to establish the relationship directly, the operating data expediently include the input data from previous examinations, for instance, by also storing that data ultimately on an event basis in a storage device. For example, data that are recorded anyway for other purposes, for instance DICOM data and/or service data, which are recorded as part of examinations performed by the at least one image acquisition apparatus, can be used as the operating data. The appropriately anonymized DICOM data and service data, serving as the operating data, hence can be put to another advantageous use in the context of the present invention.

In another embodiment of the present invention, the usage schedule is created in an automated manner, in particular in the context of an optimization algorithm that minimizes idle times and/or maximizes measurement times. The present invention thereby functions without any user interaction because the operating data are automatically acquired, and analyzed in terms of the examination durations by the analysis algorithm, and the scheduling can be performed in an automated manner on the basis of examination information about pending examinations. Such information can be provided, for instance, in an information system, such as a radiology information system and/or a hospital information system. Automated usage-phase scheduling, for instance daily scheduling, that involves minimum idle and waiting times is thereby possible.

In this context, it is advantageous for a scattering parameter, which defines the variability of the examinations on the basis of the operating data, to also be determined for each of the examination durations, which parameter is taken into account in the automated creation of the usage schedule. Hence the automated creation of the usage schedule for a usage phase can also incorporate information about the typical variations in time of the examination durations of specific examination classes and/or examinations in order to minimize the risk of unforeseeable events causing a large change to the usage schedule. In an embodiment of the present invention, when a scattering parameter exceeds a threshold value, a safety interval is added to the examination duration, and/or the sequence of measurements is selected that is most likely to even out the dispersion-defined deviations from the actual time slots. Thus, while it is conceivable to provide a form of time buffer when deviations frequently occur, by appropriate selection of the sequence of the examinations, it can also be achieved that any deviations that may occur can be evened out with greater probability, so that a correct appointment sequence can be achieved again with the highest probability even if an actual examination duration deviates from the value for the examination duration given by the analysis algorithm.

In this case, in principle multiple sets of input data are conceivable, representing examination parameters and/or patient parameters. For instance, a measurement protocol to be used, and/or the body region to be examined, and/or at least one workflow parameter, can be used as the examination parameters. Workflow parameters in this case may be, for example, the use of contrast agent and/or of at least one auxiliary device and/or the option for repeating measurements in the event of poor-quality measurements and/or the existence of respiratory triggering and/or a patient comfort parameter. In the example of a magnetic resonance apparatus as the image acquisition apparatus, auxiliary devices may include, for instance, local coils, elastography devices, monitors for functional magnetic resonance imaging and the like. Thus whenever additional hardware is required, a difference in the examination durations may arise, in which case it is also possible to differentiate between different auxiliary devices. Workflows may also exist for which one of the at least one measurement protocols is repeated again if image quality is poor. Patient comfort parameters may define, for example, the intended positioning of the patient during the examination, for instance how unpleasant the position generally is for the patient. For example, if local coils are arranged under the patient, this can cause a feeling of discomfort and hence a reduced ability to maintain a particular position exactly.

Examples of parameters that can be used as the patient parameters are the BMI (body mass index) of the patient and/or the age of the patient and/or a stationary or ambulant status of the patient and/or a size of the patient and/or a gender of the patient and/or a maximum breath-hold duration of the patient and/or a cooperation parameter specifying the willingness of the patient to cooperate. Thus even the patient can have an effect on the examination duration, which effect can be learned over time from the technical operating data. Examination durations can depend, for example, on patient characteristics such as BMI, age, stationary/ambulant, size, fat content, maximum breath-hold time and the like.

The present invention relates not only to the method but also to a scheduling computer, which has a processor designed to perform the method according to the invention. All the embodiments relating to the method according to the invention can be applied analogously to the scheduling computer according to the invention, and therefore the aforementioned advantages can likewise be achieved by such a computer. It is particularly expedient for the scheduling computer to be part of an information system, in particular a radiology information system (RIS) or a hospital information system (HIS), and/or be connected to such a system. The image acquisition apparatuses themselves can expediently also be connected to the information system in order to provide the operating data in said system. An analysis module of the scheduling computer, which module implements the analysis algorithm, can then analyze the operating data to determine examination durations, while advantageously a scheduling unit is additionally provided that performs the automatic scheduling of usage phases.

The present invention also encompasses a non-transitory, computer-readable data storage medium encoded with programming instructions that, when loaded into a scheduling computer, cause the scheduling computer to implement any or all of the above-described embodiments of the method according to the invention.

### BRIEF DESCRIPTION OF THE DRAWINGS

FIG. 1 illustrates a system with which the method according to the invention can be performed.

FIG. 2 illustrates the method according to the invention.

### DESCRIPTION OF THE PREFERRED EMBODIMENTS

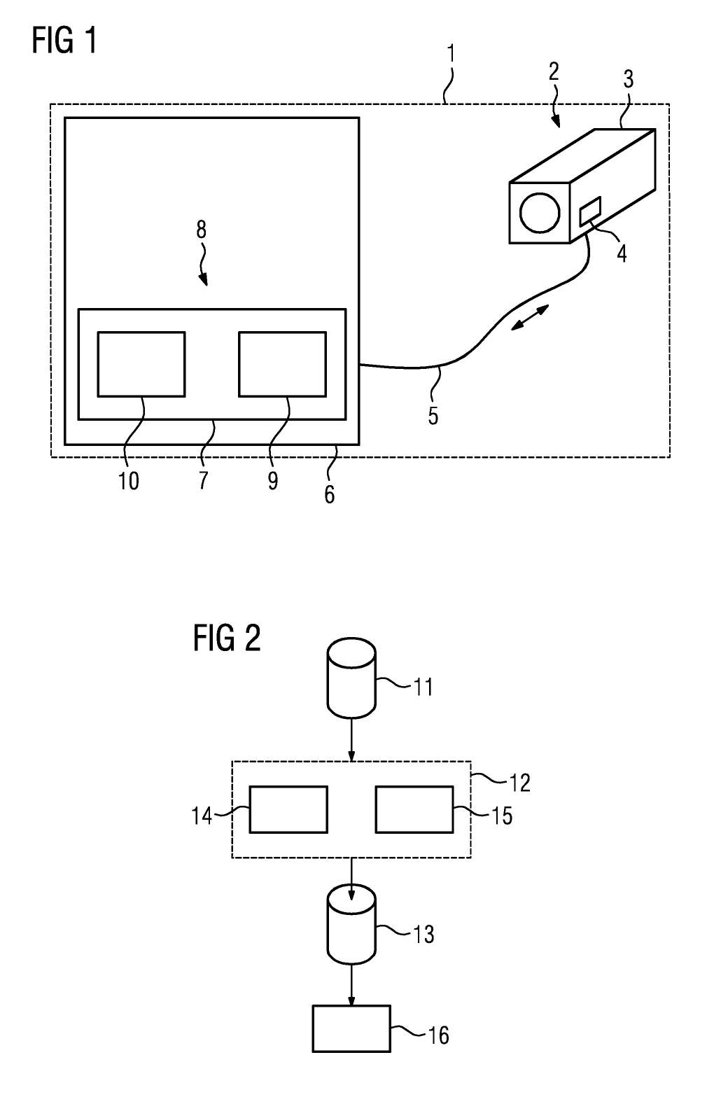

FIG. 1 shows an examination system 1 in which the method according to the invention can be employed. The examination system 1 includes an image acquisition apparatus 2, in the present case a magnetic resonance apparatus, which includes a data acquisition scanner 3. There may also be a group of multiple image acquisition apparatuses 2 of the same imaging modality, for instance a number of magnetic resonance apparatuses 3, which are located at a single medical examination center, for example at a radiology clinic or a hospital.

Inside the magnetic resonance apparatus 3, during usage phases of the magnetic resonance apparatus 3, a control device 4 of the magnetic resonance apparatus 3 records and saves technical operating data, which in the present case also includes operating events with associated time stamp. The operating data may be, for example, DICOM data and/or service data, which is acquired anyway. The control computer 4 has a communication connection 5 with an information system 6, for instance a radiology information system (RIS) or a hospital information system (HIS), so that not only can measured image data be provided, for example to an image archiving system of the information system 6, but also, via the communication connection 5, the information system 6 gains access to the operating data in anonymized form, which the control computer 4 records.

The operating data can be used in a scheduling computer 8, which includes a processor 7 designed to perform the exemplary embodiment described below of the method according to the invention and is part of the information system 6, in order to derive not only examination durations for forthcoming examinations by an analysis module 9 implementing an analysis algorithm but also to facilitate automatic scheduling of a forthcoming usage phase by a scheduling unit 10.

The exemplary embodiment of the method according to the invention shall be explained in greater detail with reference to FIG. 2. The starting point is the operating data 11 from the past, from which the analysis algorithm 12 derives examination durations 13 for future examinations. There are essentially two ways of doing this, which in principle can also be used cumulatively.

In a less preferred variant, the analysis algorithm 12 uses a statistical analysis 14, to determine examination durations for specific examination classes. These examination classes are defined here by predetermined examination parameters and patient parameters as input data, or more precisely by certain value ranges and/or values of this input data. Input data that can be used to define examination classes of examinations and which may also be included correspondingly comprises as examination parameters, for example, the at least one measurement protocol to be used, the body region (head, shoulder, . . . ) to be examined and at least one workflow parameter. Workflow parameters can define whether contrast agent and/or at least one auxiliary device is used, whether local coils or breath-holding are employed and/or whether circumstances exist that limit patient comfort. The input data can include as the patient parameters, for example, the age of the patient, the gender of the patient, the BMI of the patient, a maximum breath-hold duration of the patient and a cooperation parameter specifying the willingness of the patient to cooperate. Time values for examinations in the operating data 11 that correspondingly belong to the examination class are determined by analysis, and the corresponding mean examination durations are obtained from these time values by statistical analysis 14. In addition, scattering parameters are also determined that specify the typically occurring time deviations from mean examination durations.

If the analysis algorithm 12 is a self-learning algorithm 15 in artificial intelligence, for instance a neural network, which is also designed for trend analysis, training data is derived or extracted from the operating data 11 as pairs consisting of input data and examination durations. The use of a self-learning algorithm 15 in artificial intelligence has the advantage that ultimately it is possible to make a finer classification and also to handle combinations of input data that had not occurred previously.

In both cases, i.e. both when using statistical analysis 14 and when using the self-learning algorithm 15, for the examination durations from the statistical analysis 14 or from the algorithm 15, the more recent operating data 11 (i.e. newly added operating data 11 that are more up to date) are included in the determination of the examination durations 13 with a higher weighting than older operating data 11, in order to be able to capture current trends.

In a step 16, a scheduling algorithm is used, for instance, to perform the automatic scheduling of the sequence of the examinations for a usage phase, which can be done, for example, on the basis of information about pending examinations, which can be available to the information system 6. The information about pending examinations can include both information about the examination objective, i.e. the examination parameters, and patient parameters, so that the input data can be derived therefrom. It is also possible to include information on priority settings and the like. The scheduling algorithm, which is designed as an optimization algorithm, now selects in step 16 a sequence of examinations for the next usage phase, if applicable additionally taking into account priority settings, which allow minimum idle times and waiting times at the magnetic resonance device 3 for which the examination durations 13 are used.

This scheduling can also use the aforementioned scattering parameters, which obviously can also be determined in the self-learning algorithm 15 in artificial intelligence, in which case the sequence of examinations is advantageously selected that is most likely to even out the deviations from the actual time slots, which deviations are given by the variabilities specified by the dispersion parameter. It can also be provided that when a scattering parameter exceeds a threshold value, a safety interval is added to the examination duration. It should also be pointed out that in principle, under defined boundary conditions, the usage schedule for the usage phase can obviously also be updated dynamically.

Although modifications and changes may be suggested by those skilled in the art, it is the intention of the Applicant to embody within the patent warranted hereon all changes and modifications as reasonably and properly come within the scope of the Applicant's contribution to the art.

1. A method for scheduling operation of a medical image acquisition apparatus comprising:
in a computer, generating a usage schedule during a usage phase of said medical image acquisition apparatus in which time slots of the usage phase are assigned to examinations of a patient, each of said examinations being implemented by executing at least one image data acquisition protocol;
with said computer, filling respective time slots of said usage phase by predicting respective examination durations of the examinations of the patient to be conducted in a respective time slot using input data provided to the computer selected from the group consisting of input data representing at least one examination parameter of at least one of the examinations of the patient, and input data specifying the patient;
in said computer, predicting said examination durations by executing an analysis algorithm that determines the respective examination durations using said input data and operating data recorded during operation of said image data acquisition apparatus, or another image data acquisition apparatus allocated to a group of image data acquisition apparatuses that all operate according to a same imaging modality as the image data acquisition apparatus for which said usage schedule is being generated; and
in said computer, producing an electrical signal representing the generated usage schedule, and making the electrical signal available as an output from said computer.

2. A method as claimed in claim 1 comprising, in said computer, executing said analysis algorithm with a statistical evaluation of time values derived from said operating data, which describe examination classes in which said examinations are grouped.

3. A method as claimed in claim 2 comprising, in said computer in said analysis algorithm, defining said examination classes by specified ranges or values of said input data.

4. A method as claimed in claim 1 comprising using a self-learning algorithm in said computer as said analysis algorithm, said self-learning algorithm comprising training data that includes at least some of said operating data or training data derived automatically from said operating data.

5. A method as claimed in claim 1 comprising selecting said operating data from the group consisting of input parameters provided to said image data acquisition device or to an image data acquisition device in said group for a previous examination, and DICOM data, and service data.

6. A method as claimed in claim 1 comprising generating said usage schedule by also executing, in said computer, an optimization algorithm in which at least one of idle times are minimized, and measurement times are maximized.

7. A method as claimed in claim 6 comprising implementing said optimization algorithm using a scattering parameter that defines a time variability of said examinations based on said operating data.

8. A method as claimed in claim 7 comprising, if said scattering parameter exceeds a threshold value, adding a safety interval to the determined examination duration, or selecting a sequence of examinations that is most likely to uniformly distribute dispersion-defined deviations from the actual time slots.

9. A method as claimed in claim 1 comprising using, as said at least one examination parameter, a parameter selected from the group consisting of a measurement protocol, a body region to be examined, and a workflow parameter.

10. A method as claimed in claim 1 comprising using, as said at least one patient parameter, a parameter selected from the group consisting of BMI of the patient, age of the patient, a stationary status of the patient, an ambulatory status of the patient, a size of the patient, a gender of the patient, a maximum breath-hold duration capacity of the patient, and a parameter specifying an ability of the patient to cooperate in said examinations.

11. A method as claimed in claim 1 comprising generating said usage schedule for a magnetic resonance apparatus or a computed tomography apparatus as said image data acquisition apparatus.

12. A method as claimed in claim 1 comprising utilizing, as said group, all image data acquisition apparatuses having a same imaging modality in a single medical examination center.

13. A computer for scheduling operation of a medical image acquisition apparatus comprising:
a processor configured to generate a usage schedule during a usage phase of said medical image acquisition apparatus in which time slots of the usage phase are assigned to examinations of a patient, each of said examinations being implemented by executing at least one image data acquisition protocol;
an input interface in communication with said processor;
said processor being configured to fill respective time slots of said usage phase by predicting respective examination durations of the examinations of the patient to be conducted in a respective time slot using input data provided to the processor via said input interface, selected from the group consisting of input data representing at least one examination parameter of at least one of the examinations of the patient, and input data specifying the patient;
said processor being configured to predict said examination durations by executing an analysis algorithm that determines the respective examination durations using said input data and operating data recorded during operation of said image data acquisition apparatus, or another image data acquisition apparatus allocated to a group of image data acquisition apparatuses that all operate according to a same imaging modality as the image data acquisition apparatus for which said usage schedule is being generated;
an output interface in communication with said processor; and
said processor being configured to produce an electrical signal representing the generated usage schedule, and to make the electrical signal available as an output from said processor via said output interface.

14. A computer as claimed in claim 13 wherein said processor is configured to access an information system in order to obtain at least one of said input data and said operating data, said information system being selected from the group consisting of an RIS and an HIS.

15. A non-transitory, computer-readable data storage medium encoded with programming instructions, said storage medium being loaded into a scheduling computer for scheduling operation of an image data acquisition apparatus, said programming instructions causing said scheduling computer to:
generate a usage schedule during a usage phase of said medical image acquisition apparatus in which time slots of the usage phase are assigned to examinations of a patient, each of said examinations being implemented by executing at least one image data acquisition protocol;
fill respective time slots of said usage phase by predicting respective examination durations of the examinations of the patient to be conducted in a respective time slot using input data provided to the scheduling computer selected from the group consisting of input data representing at least one examination parameter of at least one of the examinations of the patient, and input data specifying the patient;
predict said examination durations by executing an analysis algorithm that determines the respective examination durations using said input data and operating data recorded during operation of said image data acquisition apparatus, or another image data acquisition apparatus allocated to a group of image data acquisition apparatuses that all operate according to a same imaging modality as the image data acquisition apparatus for which said usage schedule is being generated; and
produce an electrical signal representing the generated usage schedule, and make the electrical signal available as an output from said scheduling computer.
